(19) United States
(12) Patent Application Publication
(10) Pub. No.: US 2010/0055370 A1
(43) Pub. Date: Mar. 4, 2010

(54) ADHESIVE COMPOSITION FOR SELF-ADHESIVE REDETACHABLE ARTICLES BASED ON ADHESIVE POLYMERS AND ORGANIC NANOPARTICLES

(75) Inventors: Heiko Diehl, Fussgoenheim (DE); Andree Dragon, Speyer (DE); Petra Schöcker, Buerstadt (DE)

Correspondence Address: OBLON, SPIVAK, MCCLELLAND MAIER & NEUSTADT, L.L.P., 1940 DUKE STREET, ALEXANDRIA, VA, 22314, US

(73) Assignee: BASF SE, Ludwigshafen (DE)

(21) Appl. No.: 12/546,091

(22) Filed: Aug. 24, 2009

(30) Foreign Application Priority Data
Aug. 26, 2008 (EP) 08162983.4

(51) Int. Cl. B32B 27/00; C09J 133/10; C09J 133/08; C09J 133/18; C09J 171/00; C08F 112/08

(52) U.S. Cl. 428/40.6; 524/502; 524/519; 524/523; 524/525; 428/327; 428/41.3; 526/346

(57) ABSTRACT

A description is given of an adhesive composition comprising, in a solvent, at least one first organic polymer and at least one different, particulate, second organic polymer. The first polymer is an adhesive polymer having a glass transition temperature of less than or equal to 0° C. which forms a film on a substrate. The second polymer is present in the composition in the form of dispersed solid nanoparticles, has an average particle size of less than or equal to 50 nm and a glass transition temperature of at least 50° C., and does not form a film on a substrate. The composition can be used to produce redetachable self-adhesive articles, more particularly paper labels, film labels or adhesive sheets.

The invention relates to an adhesive composition containing a first, film-forming organic polymer with a low glass transition temperature and a second, nonfilm-forming, nanoparticulate organic polymer having a high glass transition temperature, and also to self-adhesive articles, preferably redetachable, which are coated with this composition.

For many applications, there is a desire for self-adhesive articles, such as labels, sheets, and tapes, for example, that can later be removed again easily from the substrate. The self-adhesive articles are on the one hand to have good adhesion to the substrate; on the other hand, after the labels, tapes or sheets have been removed, there should be no residues left on the substrate. Known self-adhesive articles have a pressure-sensitive adhesive (PSA). With many PSAs, the initial tack is of itself too high for easy redetachability, or there may be an increase in tack over time, with the result that, after a prolonged time, the article can no longer be easily detached from the substrate or else, following detachment, unwanted residues are left on the substrate to an increased extent.

Redetachable self-adhesive articles are known for which the reduced tack and the redetachability are achieved through the addition of microparticulate inorganic particles, silica gel particles being one example. These particles are abrasive and can lead to increased wear of apparatus during production. Moreover, increased cost and complexity are needed for stabilization, since the particles can easily settle in aqueous dispersions.

WO 2006/025957 describes resin dispersions having a multimodal particle size distribution. The softening temperatures of the resins can be situated in the range from 30 to 160° C. EP 1371704 and EP 1371705 disclose dispersions containing polymeric nanoparticles. From the table of example 2 of EP 1371705 it is apparent that the addition of the polymeric nanoparticles used therein leads to less ready redetachability (higher peel values). EP 1245587 describes coating compositions which comprise polymeric nanoparticles. Preferred glass transition temperatures of the polymeric nanoparticles are less than 25° C. WO 2003/072654 discloses PSA compositions which in addition to an adhesive polymer comprise a dispersion of dispersed polyethylene wax. The polyethylene forms a film with the adhesive polymer and leads to stronger bonding, as manifested in a greater shear strength and a greater peel strength.

It was an object of the invention to provide an adhesive composition, the tack being reduced to such an extent that articles coated therewith are easily redetachable after having been bonded. This easy redetachability ought as far as possible not to be adversely affected by a tack increasing with time. Nevertheless, the initial tack (quick stick) ought to be sufficiently high.

The invention provides an adhesive composition which comprises in a solvent at least one first organic polymer and at least one different second organic polymer, the glass transition temperatures of the polymers differing by at least 50° C., where
(a) the first polymer is an adhesive polymer which has a glass transition temperature of less than or equal to 0° C. and forms a film when the composition is applied to a substrate and subsequently dries, and
(b) the second polymer is present in the composition in the form of dispersed, solid nanoparticles, has an average particle size of less than or equal to 50 nm and a glass transition temperature of at least 50° C., and does not form a film when the composition is applied to a substrate and subsequently dried.

The invention also provides self-adhesive articles whose respective surface is coated at least partly with an adhesive composition of the invention. The invention also provides substrates provided with the self-adhesive articles of the invention.

The invention also provides for the use of organic polymer particles having an average particle size of less than or equal to 50 nm and a glass transition temperature of at least 50° C. to produce redetachable self-adhesive articles.

The designation (meth)acrylate and similar designations are used below as an abbreviated notation for “acrylate or methacrylate”. Solvents are understood to be vehicles which are liquid at room temperature (20° C.) and in which the polymers are present in solution or dispersion. Water is particularly preferred.

The composition comprises at least one first organic polymer. This polymer is adhesive, i.e., is capable of connecting workpieces without the workpieces themselves being notably altered, the holding-together of the connected workpieces being determined by forces of adhesion (forces of attraction between adhesive and workpiece) and cohesion (internal holding-together of the adhesive). Preferred first polymers are obtainable by free-radical polymerization of ethylenically unsaturated compounds (monomers). Particular preference is given to emulsion polymers, i.e., the reaction products of the polymerization of the monomers in aqueous dispersion.

The first polymer is composed preferably to an extent of at least 40% or at least 60% or at least 80%, more preferably at least 90%, by weight of what are called principal monomers. The principal monomers are preferably selected from C₁-C₂₀ alkyl (meth)acrylates, vinyl esters of carboxylic acids comprising up to 20 C atoms, vinylaromatics having up to 20 C atoms, ethylenically unsaturated nitriles, vinyl halides, vinyl ethers of alcohols comprising 1 to 10 C atoms, aliphatic hydrocarbons having 2 to 8 C atoms and one or two double bonds, or mixtures of these monomers.

Suitable monomers are, for example, (meth)acrylic acid alkyl esters with a C₁-C₁₀ alkyl radical, such as methyl methacrylate, methyl acrylate, n-butyl acrylate, ethyl acrylate, and 2-ethylhexyl acrylate. Also suitable in particular are mixtures of the (meth)acrylic acid alkyl esters. Vinyl esters of carboxylic acids having 1 to 20 C atoms are, for example, vinyl laurate, vinyl stearate, vinyl propionate, Versatic acid vinyl esters, and vinyl acetate. Suitable vinylaromatic compounds include vinyltoluene, α- and p-methylstyrene, α-butylstyrene, 4-n-butylstyrene, 4-n-decylstyrene, and, preferably, styrene. Examples of nitriles are acrylonitrile and methacrylonitrile. The vinyl halides are ethylenically unsaturated compounds substituted by chlorine, fluorine or bromine, preferably vinyl chloride and vinylidene chloride. Vinyl ethers include, for example, vinyl methyl ether or vinyl isobutyl ether. Preference is given to vinyl ethers of alcohols comprising 1 to 4 C atoms. Suitable hydrocarbons having 4 to 8 C atoms and two olefinically double bonds are, for example, butadiene, isosprene, and chloroprene.

Preferred principal monomers are C₁ to C₁₀ alkyl acrylates and C₁ to C₁₀ alkyl methacrylates, especially C₁ to C₈-alkyl acrylates and methacrylates, vinylaromatics, especially styrene, and hydrocarbons having 4 to 8 C atoms and two olefinic double bonds, especially butadiene, and mixtures of these monomers. Very particular preference is given to methyl acrylate, methyl methacrylate, ethyl acrylate, n-butyl acrylate, n-hexyl acrylate, octyl acrylate and 2-ethylhexyl acrylate, styrene, butadiene, and mixtures of these monomers.

Besides the principal monomers the polymer may comprise further monomers, examples being monomers having carboxylic, sulfonic or phosphonic acid groups. Carboxylic acid groups are preferred. Examples include acrylic acid, methacrylic acid, itaconic acid, maleic acid or fumaric acid. The amount of acid monomers in the polymer can be, for example, 0% to 10% by weight, especially 0.05% to 5% by weight, based on the polymer. The acid groups may be present in the form of their salts. Further monomers include, for example, hydroxyl-containing monomers, especially C₁-C₁₀ hydroxyalkyl (meth)acrylate, or (meth)acrylamide. Other further monomers include phenyloxyethylglycol mono(meth)acrylate, glycidyl(meth)acrylate, and aminoalkyl(meth)acrylates such as 2-aminoethyl(meth)acrylate, for example. Alkyl groups have preferably from 1 to 20 C atoms. Further monomers also include crosslinking monomers. The further monomers are used in general in minor amounts; their fraction overall is preferably below 10% by weight, especially below 5% by weight.

In particular the polymer is constructed to an extent of at least 60%, more preferably at least 80%, and very preferably at least 90 or at least 95% by weight of C₁ to C₂₀ alkyl(meth)acrylates. A further preferred polymer is butadiene/styrene copolymer. The nature and amount of the monomers and the proportions of different comonomers to one another are such that the glass transition temperature of the first polymer is less than or equal to 0° C., or less than or equal to −10° C. or less than or equal to −20° C., e.g., from −60 to −10° C. or from −60 to −20° C. The glass transition temperature can be determined by customary methods such as differential scanning calorimetry (see, e.g., ASTM 3418/82, midpoint temperature).

The emulsion polymers are prepared by emulsion polymerization using emulsifiers and/or protective colloids or stabilizers as surface-active substances. As surface-active substances it is preferred to employ exclusively emulsifiers, whose molecular weights, unlike those of the protective colloids, are typically below 2000 g/mol. Anionic and nonionic emulsifiers are preferably used as surface-active substances. Customary emulsifiers are, for example, ethoxylated fatty alcohols (EO degree: 3 to 50, alkyl radical: C₈ to C₃₆), ethoxylated mono-, di-, and tri-alkylphenols (EO degree: 3 to 50, alkyl radical: C₄ to C₉), and also alkali metal salts and ammonium salts of alkyl sulfates (alkyl radical: C₈ to C₁₂), of ethoxylated alkanols (EO degree: 4 to 30, alkyl radical: C₁₂ to C₁₈), of ethoxylated alkylphenols (EO degree: 3 to 50, alkyl radical: C₄ to C₉), of alkylsulfonic acids (alkyl radical: C₁₂ to C₁₈), and of alkylarylsulfonic acids (alkyl radical: C₉ to C₁₈). Commercial products of suitable emulsifiers are, for example, Dowfax® 2 A1, Emulan® NP 50, Dextrol®OC 50, Emulgator 825, Emulgator 825 S, Emulan®OG, Texapon® NSO, Nekanil® 904 S, Disponil® FES 77, Lutensol® AT 18, Steinapol VSL, Emulphor NPS 25.

The emulsion polymerization can be started using water-soluble initiators. Examples of water-soluble initiators are ammonium salts and alkali metal salts of peroxodisulfuric acid, e.g., sodium peroxodisulfate, hydrogen peroxide or organic peroxides, e.g., tert-butyl hydroperoxide. Also suitable as initiator are what are called reduction-oxidation (redox) initiator systems. The redox initiator systems are composed of at least one, usually inorganic, reducing agent and an organic or inorganic oxidizing agent. The oxidizing component comprises, for example, the aforementioned initiators for emulsion polymerization. The reducing component comprises, for example, alkali metal salts of sulfurous acid, such as sodium sulfite, sodium hydrogen sulfite, alkali metal salts of disulfurous acid such as sodium disulfite, bisulfite addition compounds of aliphatic aldehydes and ketones, such as acetone bisulfite, or reducing agents such as hydroxymethanesulfinic acid and its salts, or ascorbic acid. The redox initiator systems can be used in tandem with soluble metal compounds whose metallic component is able to occur in a plurality of valence states. Typical redox initiator systems are, for example, ascorbic acid/iron(II) sulfate/sodium peroxidisulfate, tert-butyl hydroperoxide/sodium disulfite, tert-butyl hydroperoxide/Na hydroxymethanesulfinate. The individual components, the reducing component, for example, may also be mixtures, an example being a mixture of the sodium salt of hydroxymethanesulfinic acid and sodium disulfite. It is also possible to use two or more different initiators in the emulsion polymerization.

In the polymerization it is possible to use molecular weight regulators, in amounts, for example, of 0.1 to 0.8 part by weight, per 100 parts by weight of the monomers to be polymerized. By this means it is possible to reduce the molar mass of the emulsion polymer. Suitable compounds are, for example, those having a thiol group, such as tert-butyl mercaptan, thioglycolic acid ethylacrylic esters, mercaptoethanol, mercaptopropyltrimethoxysilane or tert-dodecyl mercaptan.

The polymerization medium may be composed either of water alone or of mixtures of water and water-miscible liquids such as methanol. It is preferred to use water alone. The emulsion polymerization may be carried out either as a batch operation or in the form of a feed process, including staged or gradient procedures. Preference is given to the feed process, where a portion of the polymerization batch is introduced as an initial charge and heated to the polymerization temperature, polymerization is commenced, and then the remainder of the polymerization batch is supplied to the polymerization zone continuously, in stages or under a concentration gradient, while the polymerization is maintained. In the polymerization it is also possible to include a polymer seed in the initial charge for the purpose, for example, of improved regulation of the particle size.

The emulsion polymerization produces aqueous dispersions of the polymer which have solids contents in general of 15% to 75%, preferably of 20% to 70% or of 40% to 70% by weight. In one embodiment the dispersion, or the pressure-sensitive adhesive, comprises at least 60% by weight of dispersed first polymer. In order to be able to achieve solids contents >60% by weight, a bimodal or polymodal particle size ought to be set, since otherwise the viscosity becomes too high and the dispersion can no longer be managed. Producing a new generation of particles can be done, for example, by adding seed before or during the emulsion polymerization, by adding excess quantities of emulsifier, or by adding miniemulsions. A further advantage associated with the combination of low viscosity and high solids content is the improved coating behavior at high solids contents. Producing one or more new generations of particles can be done at any desired point in time. It is guided by the target particle size distribution for a low viscosity.

A further group of adhesive polymers which can be used as the first polymer in accordance with the invention are adhesive polyurethanes.

With preference a suitable polyurethane is one composed predominantly of polyisocyanates, especially diisocyanates, and, as co-reactants, polyesterdiols, polyetherdiols or mixtures thereof. The polyurethane is preferably synthesized from at least 40%, more preferably at least 60%, and very preferably at least 80% by weight of diisocyanates, polyetherdiols and/or polyesterdiols. With preference the polyurethane comprises polyesterdiols in an amount of more than 10%, more preferably greater than 30%, in particular greater than 40% or greater than 50%, very preferably greater than 60%, by weight, based on the polyurethane.

Polyesterdiols in particular are used as synthesis components. If polyesterdiols are used in a mixture with polyetherdiols, the proportion of polyesterdiols is preferably at least 50 mol %, more preferably at least 80 mol %, very preferably 100 mol %, of the mixture of polyesterdiols and polyetherdiols.

Preferably the polyurethane has a melting point greater than 30° C., in particular greater than 40° C., more preferably greater than 50° C. or greater than 60° C. or greater than 70° C.; in general the melting point is not greater than 150° C., in particular not greater than 100° C. The melting point is situated therefore in particular in a range from 30 to 150° C., more preferably from 40 to 150° C., and very preferably from 30 to 100° C., and in particular from 50 to 80° C. The polyurethane preferably has a melting enthalpy of more than 20 J/g. The measurement of the melting point and of the melting enthalpy takes place by the method of differential scanning calorimetry. The measurement takes place on polyurethane films 200 μm thick which prior to measurement have been dried in a forced-air drying oven at 40° C. for 72 hours. In preparation for the measurement, approximately 13 mg of the polyurethane are introduced into pans. The pans are sealed, the samples are heated to 120° C., cooled at 20 K/min and conditioned at 20° C. for 20 hours. The samples prepared in this way are subjected to measurement in accordance with the DSC method of DIN 53765, the sample being heated at 20 K/min. The melting temperature is the peak temperature to DIN 53765; the melting enthalpy is determined as in picture 4 of DIN 53765.

Overall the polyurethane is preferably synthesized from:
a) diisocyanates,
b) diols of which
b1) 10 to 100 mol %, based on the total amount of diols (b), have a molecular weight of 500 to 5000 g/mol,
b2) 0 to 90 mol %, based on the total amount of diols (b), have a molecular weight of 60 to 500 g/mol,
c) non-(a) and non-(b) monomers containing at least one isocyanate group or at least one group reactive toward isocyanate groups, and further carrying at least one hydrophilic or potentially hydrophilic group to make the polyurethanes dispersible in water,
d) if appropriate, further, non-(a) to non-(c) polyfunctional compounds containing reactive groups selected from alcoholic hydroxyl groups, primary or secondary amino groups or isocyanate groups, and
e) if appropriate, non-(a) to non-(d) monofunctional compounds containing a reactive group which is an alcoholic hydroxyl group, a primary or secondary amino group or an isocyanate group.

Particular mention may be made as monomers (a) of diisocyanates X(NCO)₂, where X is an aliphatic hydrocarbon radical having 4 to 15 carbon atoms, a cycloaliphatic or aromatic hydrocarbon radical having 6 to 15 carbon atoms, or an araliphatic hydrocarbon radical having 7 to 15 carbon atoms. Examples of such diisocyanates include tetramethylene diisocyanate, hexamethylene diisocyanate, dodecamethylene diisocyanate, 1,4-diisocyanatocyclohexane, 1-isocyanato-3,5,5-trimethyl-5-isocyanatomethylcyclohexane (IPDI), 2,2-bis(4-isocyanatocyclohexyl)propane, trimethylhexane diisocyanate, 1,4-diisocyanatobenzene, 2,4-diisocyanatotoluene, 2,6-diisocyanatotoluene, 4,4′-diisocyanato-diphenylmethane, 2,4′-diisocyanatodiphenylmethane, p-xylylene diisocyanate, tetramethylxylylene diisocyanate (TMXDI), the isomers of bis(4-isocyanatocyclohexyl)methane (HMDI) such as the trans/trans, the cis/cis, and the cis/trans isomers, and mixtures of these compounds. Diisocyanates of this kind are available commercially.

Particularly important mixtures of these isocyanates are the mixtures of the respective structural isomers of diisocyanatotoluene and diisocyanatodiphenylmethane; the mixture of 80 mol % 2,4-diisocyanatotoluene and 20 mol % 2,6-diisocyanatotoluene is particularly suitable. Also of particular advantage are the mixtures of aromatic isocyanates such as 2,4-diisocyanatotoluene and/or 2,6-diisocyanatotoluene with aliphatic or cycloaliphatic isocyanates such as hexamethylene diisocyanate or IPDI, in which case the preferred mixing ratio of the aliphatic to the aromatic isocyanates is from 4:1 to 1:4.

Compounds used to synthesize the polyurethanes, in addition to those mentioned above, also include isocyanates which in addition to the free isocyanate groups carry further, blocked isocyanate groups, e.g., uretdione groups.

With a view to effective film-forming and elasticity, suitable diols (b) are principally relatively high molecular weight diols (b1), having a molecular weight of from about 500 to 5000, preferably from about 1000 to 3000 g/mol. The molecular weight in question is the number-average molar weight Mn. Mn is obtained by determining the number of end groups (OH number). The diols (b1) may be polyesterpolyols, which are known, for example, from Ullmanns Enzyklopädie der technischen Chemie, 4th edition, volume 19, pp. 62 to 65. It is preferred to use polyesterpolyols which are obtained by reacting dihydric alcohols with dibasic carboxylic acids. Instead of the free polycarboxylic acids it is also possible to use the corresponding polycarboxylic anhydrides or corresponding polycarboxylic esters of lower alcohols or mixtures thereof to prepare the polyesterpolyols. The polycarboxylic acids can be aliphatic, cycloaliphatic, araliphatic, aromatic or heterocyclic and can, if appropriate, be substituted, by halogen atoms for example, and/or unsaturated. Examples thereof include the following: suberic acid, azelaic acid, phthalic acid, isophthalic acid, phthalic anhydride, tetrahydrophthalic anhydride, hexahydrophthalic anhydride, tetrachlorophthalic anhydride, endomethylenetetrahydrophthalic anhydride, glutaric anhydride, maleic acid, maleic anhydride, fumaric acid, and dimeric fatty acids. Preferred dicarboxylic acids are those of the general formula HOOC—(CH₂)_{y}—COOH, where y is a number from 1 to 20, preferably an even number from 2 to 20, examples being succinic acid, adipic acid, sebacic acid, and dodecanedicarboxylic acid.

Examples of suitable polyhydric alcohols include ethylene glycol, propane-1,2-diol, propane-1,3-diol, butane-1,3-diol, butene-1,4-diol, butyne-1,4-diol, pentane-1,5-diol, neopentyl glycol, bis(hydroxymethyl)cyclohexanes such as 1,4-bis(hydroxymethyl)-cyclohexane, 2-methylpropane-1,3-diol, methylpentanediols, and also diethylene glycol, triethylene glycol, tetraethylene glycol, polyethylene glycol, dipropylene glycol, polypropylene glycol, dibutylene glycol, and polybutylene glycols. Preferred alcohols are those of the general formula HO—(CH₂)ₓ—OH, where x is a number from 1 to 20, preferably an even number from 2 to 20. Examples of such alcohols include ethylene glycol, butane-1,4-diol, hexane-1,6-diol, octane-1,8-diol, and dodecane-1,12-diol. Preference is also given to neopentyl glycol.

Suitability is also possessed, if appropriate, by polycarbonatediols, such as may be obtained, for example, by reacting phosgene with an excess of the low molecular weight alcohols specified as synthesis components for the polyesterpolyols.

It may also be possible, if appropriate, to use lactone-based polyesterdiols, which are homopolymers or copolymers of lactones, preferably hydroxy-terminated adducts of lactones with suitable difunctional starter molecules. Preferred lactones are those derived from compounds of the general formula HO—(CH₂)_{z}—COOH, where z is a number from 1 to 20 and where one hydrogen atom of a methylene unit may also be substituted by a C₁ to C₄ alkyl radical. Examples are ε-caprolactone, β-propiolactone, γ-butyrolactone and/or methyl-ε-caprolactone, and mixtures thereof. Examples of suitable starter components are the low molecular weight dihydric alcohols specified above as a synthesis component for the polyesterpolyols. The corresponding polymers of ε-caprolactone are particularly preferred. Lower polyesterdiols or polyetherdiols as well can be used as starters for preparing the lactone polymers. Instead of the polymers of lactones it is also possible to use the corresponding chemically equivalent polycondensates of the hydroxycarboxylic acids corresponding to the lactones.

Polyetherdiols are obtainable in particular by polymerizing ethylene oxide, propylene oxide, butylene oxide, tetrahydrofuran, styrene oxide or epichlorohydrin with itself, in the presence of BF₃ for example, or by subjecting these compounds, if appropriate in a mixture or in succession, to addition reaction with starter components containing reactive hydrogen atoms, such as alcohols or amines, examples being water, ethylene glycol, propane-1,2-diol, propane-1,3-diol, 2,2-bis(4-hydroxyphenyl)propane, and aniline. Particular preference is given to polypropylene oxide, polytetrahydrofuran with a molecular weight of from 240 to 5000, and in particular of from 500 to 4500.

Compounds subsumed under b1) include only those polyetherdiols composed to an extent of less than 20% by weight of ethylene oxide. Polyetherdiols with at least 20% by weight are hydrophilic polyetherdiols, which are counted as monomers c). It may also be possible, if appropriate, to use polyhydroxyolefins, preferably those having 2 terminal hydroxyl groups, e.g., α,ω-dihydroxypolybutadiene, α,ω-dihydroxy-polymethacrylic esters or α,ω-dihydroxypolyacrylic esters, as monomers (c1). Such compounds are known for example from EP-A 622 378. Further suitable polyols are polyacetals, polysiloxanes, and alkyd resins.

Preferably at least 30 mol %, more preferably at least 70 mol %, of the diols b1) are polyesterdiols. With particular preference polyesterdiols exclusively are used as diols b1).

The hardness and the elasticity modulus of the polyurethanes can be increased by using as diols (b) not only the diols (b1) but also low molecular weight diols (b2) having a molecular weight of from about 60 to 500, preferably from 62 to 200 g/mol. Monomers (b2) used are in particular the synthesis components of the short-chain alkanediols specified for preparing polyesterpolyols, preference being given to unbranched diols having 2 to 12 carbon atoms and an even number of carbon atoms, and also to pentane-1,5-diol and neopentyl glycol. Examples of suitable diols b2) include ethylene glycol, propane-1,2-diol, propane-1,3-diol, butane-1,3-diol, butene-1,4-diol, butyne-1,4-diol, pentane-1,5-diol, neopentyl glycol, bis(hydroxymethyl)cyclohexanes such as 1,4-bis(hydroxymethyl)cyclohexane, 2-methylpropane-1,3-diol, methylpentanediols, additionally diethylene glycol, triethylene glycol, tetraethylene glycol, polyethylene glycol, dipropylene glycol, polypropylene glycol, dibutylene glycol, and polybutylene glycols. Preference is given to alcohols of the general formula HO—(CH₂)ₓ—OH, where x is a number from 1 to 20, preferably an even number from 2 to 20. Examples thereof are ethylene glycol, butane-1,4-diol, hexane-1,6-diol, octane-1,8-diol, and dodecane-1,12-diol. Preference is further given to neopentyl glycol.

The fraction of diols (b1), based on the total amount of diols (b), is preferably from 10 to 100 mol %, and the fraction of the monomers (b2), based on the total amount of diols (b), is preferably from 0 to 90 mol %. With particular preference the ratio of the diols (b1) to the monomers (b2) is from 0.1:1 to 5:1, more preferably from 0.2:1 to 2:1.

In order to make the polyurethanes dispersible in water they preferably comprise as synthesis components non-(a), non-(b), and non-(d) monomers (c), which carry at least one isocyanate group or at least one group reactive toward isocyanate groups and, furthermore, at least one hydrophilic group or a group which can be converted into a hydrophilic group. In the text below; the term “hydrophilic groups or potentially hydrophilic groups” is abbreviated to “(potentially) hydrophilic groups”. The (potentially) hydrophilic groups react with isocyanates at a substantially slower rate than do the functional groups of the monomers used to synthesize the polymer main chain. The fraction of the components having (potentially) hydrophilic groups among the total quantity of components (a), (b), (c), (d), and (e) is generally such that the molar amount of the (potentially) hydrophilic groups, based on the amount by weight of all monomers (a) to (e), is from 30 to 1000, preferably from 50 to 500, and more preferably from 80 to 300 mmol/kg. The (potentially) hydrophilic groups can be nonionic or, preferably, (potentially) ionic hydrophilic groups.

Particularly suitable nonionic hydrophilic groups are polyethylene glycol ethers composed of preferably from 5 to 100, more preferably from 10 to 80 repeating ethylene oxide units. The amount of polyethylene oxide units is generally from 0 to 10% by weight, preferably from 0 to 6% by weight, based on the amount by weight of all monomers (a) to (e). Preferred monomers containing nonionic hydrophilic groups are polyethylene oxide diols containing at least 20% by weight of ethylene oxide, polyethylene oxide monools, and the reaction products of a polyethylene glycol and a diisocyanate which carry a terminally etherified polyethylene glycol radical. Diisocyanates of this kind and processes for preparing them are specified in patents U.S. Pat. No. 3,905,929 and U.S. Pat. No. 3,920,598.

Ionic hydrophilic groups are, in particular, anionic groups such as the sulfonate, the carboxylate, and the phosphate group in the form of their alkali metal salts or ammonium salts, and also cationic groups such as ammonium groups, especially protonated tertiary amino groups or quaternary ammonium groups. Potentially ionic hydrophilic groups are, in particular, those which can be converted into the abovementioned ionic hydrophilic groups by simple neutralization, hydrolysis or quaternization reactions, in other words, for example, carboxylic acid groups or tertiary amino groups. (Potentially) ionic monomers (c) are described at length in, for example, Ullmanns Enzyklopädie der technischen Chemie, 4th edition, volume 19, pp. 311-313 and in, for example, DE-A 14 95 745.

Of particular practical importance as (potentially) cationic monomers (c) are, in particular, monomers containing tertiary amino groups, examples being tris(hydroxyalkyl)amines, N,N′-bis(hydroxyalkyl)alkylamines, N-hydroxyalkyldialkylamines, tris(aminoalkyl)amines, N,N′-bis(aminoalkyl)alkylamines, and N-aminoalkyldialkylamines, the alkyl radicals and alkanediyl units of these tertiary amines consisting independently of one another of 1 to 6 carbon atoms. Also suitable are polyethers containing tertiary nitrogen atoms and preferably two terminal hydroxyl groups, such as are obtainable in a conventional manner, for example, by alkoxylating amines containing two hydrogen atoms attached to amine nitrogen, such as methylamine, aniline or N,N′-dimethylhydrazine. Polyethers of this kind generally have a molar weight of between 500 and 6000 g/mol. These tertiary amines are converted into the ammonium salts either with acids, preferably strong mineral acids such as phosphoric acid, sulfuric acid, hydrohalic acids, or strong organic acids, or by reaction with suitable quaternizing agents such as C₁ to C₆ alkyl halides or benzyl halides, e.g., bromides or chlorides.

Suitable monomers having (potentially) anionic groups normally include aliphatic, cycloaliphatic, araliphatic or aromatic carboxylic acids and sulfonic acids which carry at least one alcoholic hydroxyl group or at least one primary or secondary amino group. Preference is given to dihydroxyalkylcarboxylic acids, especially those having 3 to 10 carbon atoms, such as are also described in U.S. Pat. No. 3,412,054.

Particular preference is given to compounds of the general formula (c1)

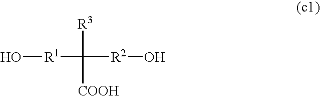

in which R¹ and R² are a C₁ to C₄ alkanediyl (unit) and R³ is a C₁ to C₄ alkyl (unit), and especially to dimethylolpropionic acid (DMPA). Also suitable are corresponding dihydroxysulfonic acids and dihydroxyphosphonic acids such as 2,3-dihydroxypropanephosphonic acid.

Otherwise suitable are dihydroxyl compounds having a molecular weight of more than 500 to 10 000 g/mol and at least 2 carboxylate groups, which are known from DE-A 39 11 827. They are obtainable by reacting dihydroxyl compounds with tetracarboxylic dianhydrides such as pyromellitic dianhydride or cyclopentanetetracarboxylic dianhydride in a molar ratio of from 2:1 to 1.05:1 in a polyaddition reaction. Particularly suitable dihydroxyl compounds are the monomers (b2) cited as chain extenders and also the diols (b1).

Suitable monomers (c) containing amino groups reactive toward isocyanates include aminocarboxylic acids such as lysine, β-alanine or the adducts of aliphatic diprimary diamines with α,β-unsaturated carboxylic or sulfonic acids that are specified in DE-A 20 34 479. Particularly preferred compounds are N-(2-aminoethyl)-2-aminoethane-carboxylic acid and also N-(2-aminoethyl)-2-aminoethanesulfonic acid and the corresponding alkali metal salts, with Na being a particularly preferred counterion. Also particularly preferred are the adducts of the abovementioned aliphatic diprimary diamines with 2-acrylamido-2-methylpropanesulfonic acid, as described for example in DE-B 1 954 090.

Where monomers with potentially ionic groups are used, their conversion into the ionic form may take place before, during or, preferably, after the isocyanate polyaddition, since the ionic monomers are frequently difficult to dissolve in the reaction mixture. Examples of neutralizing agents include ammonia, NaOH, triethanolamine (TEA), tri-isopropylamine (TIPA) or morpholine, or its derivatives. The sulfonate or carboxylate groups are particularly preferably in the form of their salts with an alkali metal ion or ammonium ion as counterion. The polyurethane comprises preferably anionic groups, especially sulfonate groups, and with particular preference carboxylate groups.

The monomers (d), which are different from the monomers (a) to (c) and which are, if appropriate, also constituents of the polyurethane, serve generally for crosslinking or chain extension. They generally comprise nonphenolic alcohols with a functionality of more than 2, amines having 2 or more primary and/or secondary amino groups, and compounds which as well as one or more alcoholic hydroxyl groups carry one or more primary and/or secondary amino groups. Alcohols having a functionality of more than 2, which may be used in order to set a certain degree of branching or crosslinking, include for example trimethylolpropane, glycerol, or sugars. Also suitable are monoalcohols which as well as the hydroxyl group carry a further isocyanate-reactive group, such as monoalcohols having one or more primary and/or secondary amino groups, monoethanolamine for example.

Polyamines having 2 or more primary and/or secondary amino groups are used especially when the chain extension and/or crosslinking is to take place in the presence of water, since amines generally react more quickly than alcohols or water with isocyanates. This is frequently necessary when the desire is for aqueous dispersions of crosslinked polyurethanes or polyurethanes having a high molar weight. In such cases the approach taken is to prepare prepolymers with isocyanate groups, to disperse them rapidly in water, and then to subject them to chain extension or crosslinking by adding compounds having two or more isocyanate-reactive amino groups. Amines suitable for this purpose are generally polyfunctional amines of the molar weight range from 32 to 500 g/mol, preferably from 60 to 300 g/mol, which contain at least two amino groups selected from the group consisting of primary and secondary amino groups. Examples of such amines are diamines such as diaminoethane, diaminopropanes, diaminobutanes, diaminohexanes, piperazine, 2,5-dimethylpiperazine, amino-3-aminomethyl-3,5,5-trimethylcyclohexane (isophoronediamine, IPDA), 4,4′-diaminodicyclohexylmethane, 1,4-diaminocyclohexane, aminoethylethanolamine, hydrazine, hydrazine hydrate or triamines such as diethylenetriamine or 1,8-diamino-4-aminomethyloctane.

The amines can also be used in blocked form, e.g., in the form of the corresponding ketimines (see for example CA-A 1 129 128), ketazines (cf. e.g. U.S. Pat. No. 4,269,748) or amine salts (see U.S. Pat. No. 4,292,226). Oxazolidines as well, as used for example in U.S. Pat. No. 4,192,937, represent blocked polyamines which can be used for the preparation of the polyurethanes of the invention, for chain extension of the prepolymers. Where blocked polyamines of this kind are used they are generally mixed with the prepolymers in the absence of water and this mixture is then mixed with the dispersion water or with a portion of the dispersion water, so that the corresponding polyamines are liberated by hydrolysis. It is preferred to use mixtures of diamines and triamines, more preferably mixtures of isophoronediamine (IPDA) and diethylenetriamine (DETA). The polyurethanes comprise preferably from 1 to 30 mol %, more preferably from 4 to 25 mol %, based on the total amount of components (b) and (d), of a polyamine having at least 2 isocyanate-reactive amino groups as monomers (d).

For the same purpose it is also possible to use, as monomers (d), isocyanates having a functionality of more than two. Examples of standard commercial compounds are the isocyanurate or the biuret of hexamethylene diisocyanate.

Monomers (e), which are used if appropriate, are monoisocyanates, monoalcohols, and mono-primary and -secondary amines. Their fraction is generally not more than 10 mol %, based on the total molar amount of the monomers. These monofunctional compounds customarily carry further functional groups such as olefinic groups or carbonyl groups and serve to introduce into the polyurethane functional groups which facilitate the dispersing and/or the crosslinking or further polymer-analogous reaction of the polyurethane. Monomers suitable for this purpose include those such as isopropenyl-α,α-dimethylbenzyl isocyanate (TMI) and esters of acrylic or methacrylic acid such as hydroxyethyl acrylate or hydroxyethyl methacrylate.

Within the field of polyurethane chemistry it is general knowledge how the molecular weight of polyurethanes can be adjusted by selecting the proportions of the mutually reactive monomers and also the arithmetic mean of the number of reactive functional groups per molecule. Components (a) to (e) and their respective molar amounts are normally chosen so that the ratio A: B, where
A is the molar amount of isocyanate groups and
B is the sum of the molar amount of the hydroxyl groups and the molar amount of the functional groups which are able to react with isocyanates in an addition reaction,
   is from 0.5:1 to 2:1, preferably from 0.8:1 to 1.5, more preferably from 0.9:1 to 1.2:1. With very particular preference the ratio A:B is as close as possible to 1:1.

The monomers (a) to (e) employed carry on average usually from 1.5 to 2.5, preferably from 1.9 to 2.1, more preferably 2.0 isocyanate groups and/or functional groups which are able to react with isocyanates in an addition reaction.

The preparation of polyurethanes, and of aqueous polyurethane dispersions, is known to the skilled worker. The polyurethanes are preferably present as aqueous dispersions and are used in this form.

The first polymers for use in accordance with the invention are used preferably in the form of an aqueous dispersion. The average particle size of the polymer particles of the first polymer that are dispersed in the aqueous dispersion is preferably from 100 to 500 nm. With particular preference the average particle size is between 140 and 200 nm. The size distribution of the dispersion particles may be monomodal, bimodal or multimodal. In the case of monomodal particle size distribution the average particle size of the polymer particles dispersed in the aqueous dispersion is preferably less than 400 nm, more particularly less than 200 nm. In the case of bimodal or multimodal particle size distribution the particle size may also be up to 1000 nm. By average particle size is meant here the d₅₀ of the particle size distribution, i.e., 50% by weight of the total mass of all the particles have a particle diameter smaller than the d₅₀. The particle size distribution can be determined in a known way using the analytical ultracentrifuge (W. Mächtle, Makromolekulare Chemie 185 (1984), pages 1025-1039).

The first polymer forms a film after application to a substrate and drying. In other words, for example, originally dispersed polymer particles after drying are no longer present in particulate form, but instead form a film on the substrate such as glass, for example.

The composition comprises at least one second organic polymer. This polymer is not adhesive; in other words, when it is used alone, it is not capable of joining workpieces by adhesion forces and cohesion. Preferred second polymers are obtainable by free-radical polymerization of ethylenically unsaturated compounds (monomers).

The second polymer is composed preferably to an extent of at least 40% or at least 60% or at least 80%, more preferably at least 90%, by weight of principal monomers, which, when they are present as homopolymers, have a glass transition temperature of at least 50° C. They may be copolymerized with comonomers which, when they are present as homopolymers, have a glass transition temperature of less than 50° C., in an amount such that the glass transition temperature of the copolymer is at least 50° C.

The principal monomers are preferably selected from vinylaromatics, especially those having up to 12 C atoms, e.g., styrene, α-methylstyrene and/or vinyltoluene. From this group of monomers it is preferred to use styrene. Examples of further monomers are methacrylic esters, acrylonitrile, methacrylonitrile, acrylamide and methacrylamide, or mixtures of these monomers. Suitable methacrylic esters are, for example, tert-butyl methacrylate, isobutyl methacrylate, ethyl methacrylate or methyl methacrylate.

In one embodiment the polymer particles of the second organic polymer are composed essentially, i.e., to an extent of at least 90%, at least 95% or 100%, by weight of vinylaromatics, especially of styrene.

The amount of second organic polymer in the adhesive composition is preferably 5% to 25% by weight, based on the overall solids content, in particular not more than 15% by weight, e.g., from 10% to 15% by weight. Within the adhesive composition the second organic polymer is in the form of solid, dispersed nanoparticles. The average particle size is not more than 50 nm or not more than 40 nm, e.g., from 10 to 40 nm, and can be determined as described above. The glass transition temperature of the second organic polymer is greater than or equal to 50° C., preferably greater than or equal to 70° C. or greater than or equal to 80° C., or at least 100° C. The second organic polymer does not film following application to a substrate and drying. In other words, even after drying, the dispersed polymer particles are still in particulate form and do not form a film on the substrate, such as glass, for example, and do not flow out with the film-forming first organic polymer. This can be ascertained by means, for example, of microscopic examinations.

The difference in the glass transition temperatures between first and second organic polymers is at least 50° C., preferably at least 70° C., at least 80° C. or at least 100° C.

Within the adhesive composition of the invention the first polymer is in dispersion or solution in the solvent. The second polymer is in dispersed form. The solvent of the adhesive composition may be composed either of water alone or of mixtures of water and water-miscible liquids such as methanol or ethanol. It is preferred to use just water. The pH of the polymer dispersion or of the adhesive composition is preferably set to a level of greater than 4.5, more particularly to a pH between 5 and 8.

The pressure-sensitive adhesive compositions may be composed solely of the solvent and the first and second organic polymers. Alternatively the adhesive composition may comprise further additives as well, examples being fillers, dyes, flow control agents, thickeners (preferably associative thickeners), defoamers, plasticizers, pigments, wetting agents or tackifiers (tackifying resins). For improved surface wetting the adhesives may comprise wetting assistants, e.g., fatty alcohol ethoxylates, alkylphenol ethoxylates, nonylphenol ethoxylates, polyoxyethylenes, polyoxypropylenes or sodium dodecylsulfonates. The amount of additives is generally 0.05 to 5 parts by weight, more particularly 0.1 to 3 parts by weight, per 100 parts by weight of polymer (solids).

In one embodiment the adhesive composition of the invention is an aqueous dispersion containing
(a) 20% to 70% by weight of an adhesive emulsion polymer having a glass transition temperature of −60 to −10° C. as first polymer, obtainable by free-radical addition polymerization and composed to an extent of at least 40% by weight of principal monomers which are selected from the group consisting of C1 to C20 alkyl (meth)acrylates, vinyl esters of carboxylic acids comprising up to 20 C atoms, vinylaromatics having up to 20 C atoms, ethylenically unsaturated nitrites, vinyl halides, vinyl ethers of alcohols comprising 1 to 10 C atoms, aliphatic hydrocarbons having 2 to 8 C atoms and one or two double bonds, and mixtures of these monomers; and
(b) 5% to 25% by weight of particulate, solid second polymer having a glass transition temperature of greater than or equal to 70° C. and an average particle size of the polymer particles of 10 to 40 nm.

The adhesive composition of the invention is preferably a pressure-sensitive adhesive (PSA). A pressure-sensitive adhesive is a viscoelastic adhesive whose set film at room temperature (20° C.) in the dry state remains permanently tacky and adhesive. The adhesion to substrates is accomplished immediately by gentle application of pressure.

The adhesive composition of the invention can be used to produce self-adhesive articles. Preferably the self-adhesive articles are removable after bonding. The self-adhesive articles may be, for example, sheets, tapes or labels.

Self-adhesive sheets of the invention preferably comprise a thermoplastic film coated on one side with the adhesive. Suitability is possessed by appropriate polymer films, such as films of polyolefins, examples being polyethylene, polypropylene, polyolefin copolymers, films of polyesters or polyacetate. The system in question may also comprise a film laminate composed of different polymer films. If appropriate it is possible for an adhesion promoter to be applied to the surface of the film in order to improve the adhesion of the adhesive layer. Self-adhesive tapes of the invention may comprise single-sidedly or double-sidedly coated tapes comprising the above substances. Self-adhesive labels of the invention may comprise labels of paper or of a thermoplastic film. Suitable thermoplastic films are the polymer films recited above. The labels are coated with adhesive on one side. Preferred substrates for the self-adhesive articles are paper and polymer films. Preferred self-adhesive articles are paper labels, film labels, adhesive tapes, and adhesive sheets.

The articles are coated at least partly on at least one surface with an adhesive composition of the invention. The adhesive may be applied to the articles by conventional methods such as knife coating or spreading. The amount is preferably 0.1 to 20 g, more preferably 2 to 15 g, of solid per m². Application is generally followed by a drying step for the purpose of removing the water and/or solvents.

The substrates to which the self-adhesive articles may advantageously be applied may be, for example, metal, wood, glass, paper or plastic. The self-adhesive articles are especially suitable for bonding to surfaces of packaging, cardboard boxes, plastic packaging, books, windows, vehicle bodies or bodywork parts. The self-adhesive articles can be removed from the substrates again by hand, without leaving a residue of adhesive on the substrate. Adhesion to the substrates is good, and yet the sheets, tapes, and labels are easily removed. This good removability exists even after a prolonged period of time.

### EXAMPLES

### Example 1

A removable PSA label is produced from a polyethylene film in a strip width of 25 mm, which is coated with 19 g/m² of an adhesive composition.

The adhesive composition comprises Acronal® DS 3588, in which organic nanoparticles are dispersed in a weight ratio of 80 parts Acronal DS 3588 to 20 parts nanoparticles. The organic nanoparticles are polystyrene particles with an average size of 25-30 nm and a glass transition temperature of greater than 80° C. Acronal® DS 3588 is a dispersion of an acrylate polymer with a solids content of 51% and a glass transition temperature of less than −10. The acrylate polymer is a copolymer of butyl acrylate, ethylhexyl acrylate, methyl acrylate, styrene, and acrylic acid.

### Example 2

### Comparative

For comparison a removable PSA label was produced in the same way as in example 1, without the organic nanoparticles.

### Investigation Method

The removability (peel test, peel strength) is investigated as follows. The peel strength is the force with which an adhesive applied to a carrier material opposes removal from the substrate at a defined removal speed.

The adhesive under test is applied to the carrier material in the desired layer thickness, using a suitable laboratory coating table, and dried in a forced-air drying cabinet at 90° C. for 3 minutes. The adhesive side of the coated carrier material is lined with release paper. Test strips are cut in a width of 25 mm, in coating direction, from the finished coating, and are stored under standard conditions (23° C., 50% relative humidity) for at least 16 hours.

The release paper is peeled from the test strip, and the strip is placed onto the test substrate by hand, without additional pressure, without bubbles, using a rubber-coated laminating roller, followed by rolling back and forth 2 times (the roller passes over the bond a total of 4 times). Testing takes place under standard conditions on a tensile testing machine. After the predetermined dwell time has elapsed, the test strip is removed halfway, from the bottom end, and turned upward at an angle of 180°. The end of the test substrate that is now free is clamped into the tensile testing machine, and the test strip is removed at an angle of 180 degrees and at a machine speed of 300 mm/minute. After each measurement the test substrate is replaced. At least 3 individual measurements are carried out. The test results are reported in N/mm width.

The investigations were carried out with the following parameters:

Carrier material: polyethylene film/silicone release paper

Test conditions: 23° C., 50% relative humidity

Width of test strip: 25 mm

Adhesive coatweight: 19 g/m²

Substrate: glass

The results are summarized in the table below:

| | Peel in N/25 mm | Peel in N/25 mm |
|---|---|---|
| Composition | 1 min dwell time | 24 h dwell time |
| Example 1 | 1.0 | 1.0 |
| Example 2 (comparative) | 1.7 | 3.2 |

1. An adhesive composition which comprises in a solvent at least one first organic polymer and at least one different second organic polymer, the glass transition temperatures of the polymers differing by at least 50° C., where
(a) the first polymer is an adhesive polymer which has a glass transition temperature of less than or equal to 0° C. and forms a film when the composition is applied to a substrate and subsequently dries, and
(b) the second polymer is present in the composition in the form of dispersed, solid nanoparticles, has an average particle size of less than or equal to 50 nm and a glass transition temperature of at least 50° C., and does not form a film when the composition is applied to a substrate and subsequently dried.

2. The adhesive composition according to claim 1, which is a pressure-sensitive adhesive composition in the form of an aqueous dispersion, comprising as first polymer an adhesive emulsion polymer.

3. The adhesive composition according to either of the preceding claims, wherein the amount of first polymer is from 20% to 70% by weight and the amount of the second polymer is from 5% to 25% by weight.

4. The adhesive composition according to any of the preceding claims, wherein the first polymer is a polymer which is obtainable by free-radical addition polymerization and is composed to an extent of at least 40% by weight of principal monomers which are selected from the group consisting of C₁ to C₂₀ alkyl (meth)acrylates, vinyl esters of carboxylic acids comprising up to 20 C atoms, vinylaromatics having up to 20 C atoms, ethylenically unsaturated nitrites, vinyl halides, vinyl ethers of alcohols comprising 1 to 10 C atoms, aliphatic hydrocarbons having 2 to 8 C atoms and one or two double bonds, and mixtures of these monomers.

5. The adhesive composition according to claim 1, wherein the first polymer is a polyurethane.

6. The adhesive composition according to any of the preceding claims, wherein the second polymer is a polymer which is obtainable by free-radical addition polymerization and which is composed of at least one vinylaromatic.

7. The adhesive composition according to any of the preceding claims, wherein the glass transition temperature of the first polymer is from −60 to −10° C.

8. The adhesive composition according to any of the preceding claims, wherein the glass transition temperature of the second polymer is greater than or equal to 70° C.

9. The adhesive composition according to any of the preceding claims, wherein the average particle size of the polymer particles of the second polymer is from 10 to 40 nm.

10. The adhesive composition according to any of the preceding claims, wherein it is an aqueous dispersion containing
(a) 20% to 70% by weight of an adhesive emulsion polymer having a glass transition temperature of −60 to −10° C. as first polymer, obtainable by free-radical addition polymerization and composed to an extent of at least 40% by weight of principal monomers which are selected from the group consisting of C₁ to C₂₀ alkyl (meth)acrylates, vinyl esters of carboxylic acids comprising up to 20 C atoms, vinylaromatics having up to 20 C atoms, ethylenically unsaturated nitrites, vinyl halides, vinyl ethers of alcohols comprising 1 to 10 C atoms, aliphatic hydrocarbons having 2 to 8 C atoms and one or two double bonds, and mixtures of these monomers; and
(b) 5% to 25% by weight of particulate, solid second polymer having a glass transition temperature of greater than or equal to 70° C. and an average particle size of the polymer particles of 10 to 40 nm.

11. A self-adhesive article, at least one surface of a substrate being at least partly coated with an adhesive composition according to any of claims 1 to 9.

12. The self-adhesive article according to claim 11, wherein the substrate is paper or a polymer film.

13. The self-adhesive article according to claim 11 or 12, which is removable and is a paper label, a film label, an adhesive tape or an adhesive sheet.

14. A substrate provided with a removable sheet, tape or label according to the preceding claim.

15. The use of organic polymer particles having an average particle size of less than or equal to 50 nm and a glass transition temperature of at least 50° C. to produce redetachable self-adhesive articles.

16. The use according to the preceding claim, wherein the polymer particles are composed substantially of polystyrene.
